(19) United States
(12) Patent Application Publication
(10) Pub. No.: US 2005/0280554 A1
(43) Pub. Date: Dec. 22, 2005

(54) Safety arrow tool for pedestrian

(76) Inventors: Frank Chan, Plano, TX (US); Tyson Chan, Allen, TX (US)

Correspondence Address: FRANK CHAN, 2445 BRYCE-WOOD LANE, PLANO, TX, 75025, US

(21) Appl. No.: 10/872,168

(22) Filed: Jun. 21, 2004

(51) Int. Cl. G08G 1/07

(52) U.S. Cl. 340/925; 340/573.1

(57) ABSTRACT

Safety Arrow Tool for Pedestrian is an easy to use and yet powerful to increase the awareness to the incoming drivers from the street when their vehicles approach to the intersection and quickly identify the object—Safety Arrow Tool when it is flashing and the person who would like to cross the street also benefits to get to the attention prior to cross the street safely. This ‘Safety Arrow’ is a plastic/Polyethylene material arrow tool with a handle that it can be carried to/from school when crossing street in the school zone for the school children (about the age of 5-14) with their parents or it also can be a sign's tool for training for school children who how to cross the street safely and it also benefit to the pedestrians and elderly person. This is a 12-inch arrow made by plastic with a handle with the electronic circuit built inside the Safety Arrow and the function of the circuit is using a 9v battery to light up the electronic LEDs/Lamps in a sequence of flashing from one side of the end of Safety Arrow to the front pointed arrow but the light will transmit from the two sides of the Safety Arrow in which it indicates to the drivers of the vehicles or motorcycle or bicycle or people and alerting them when the drivers approach too close to the children or the pedestrian while they are holding the Safety Arrow tool before across the street safely.

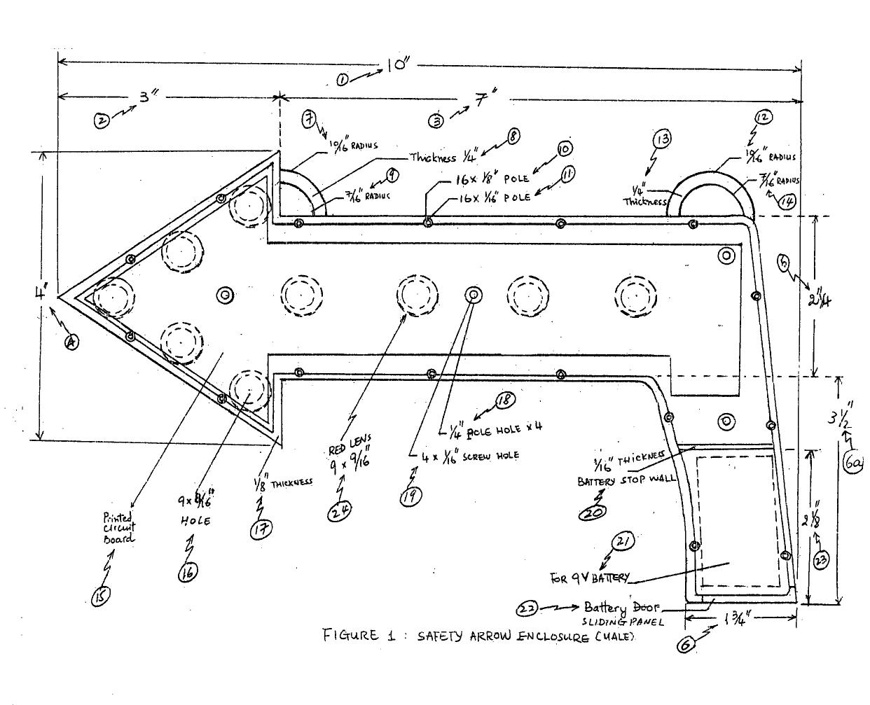

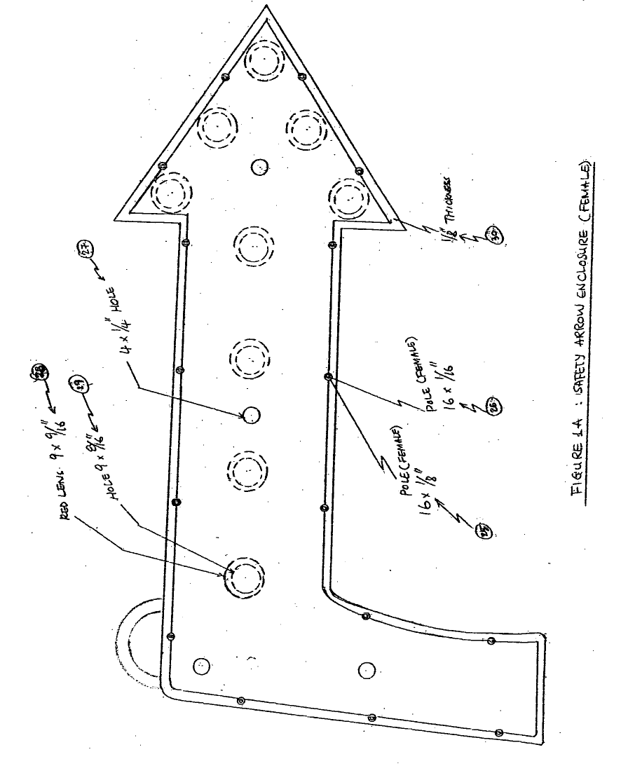

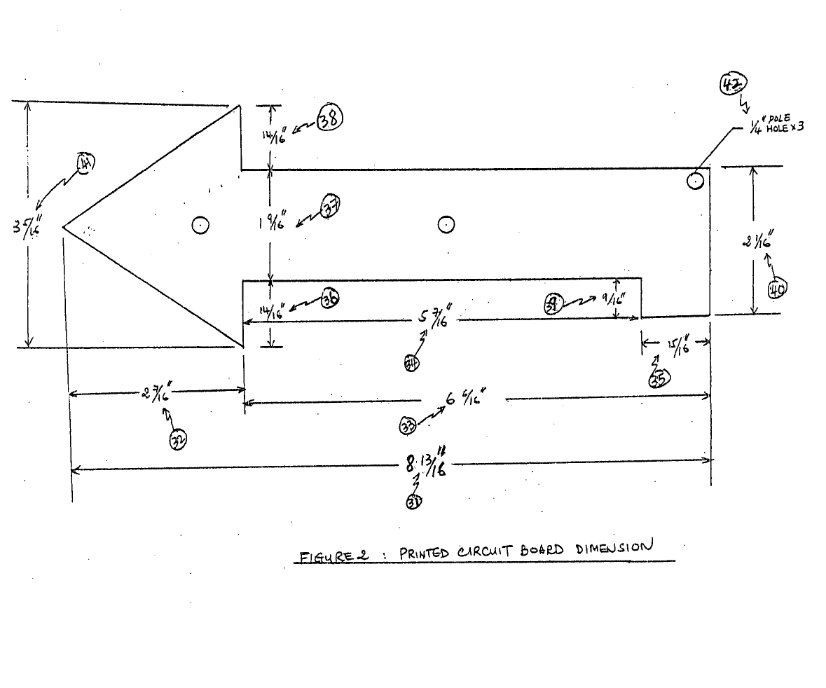

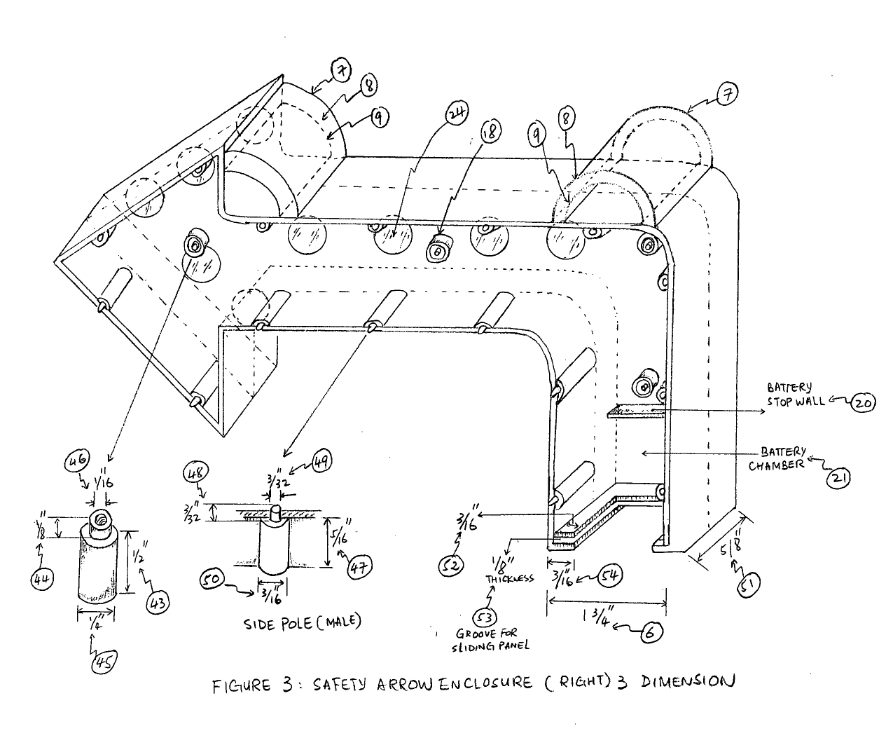

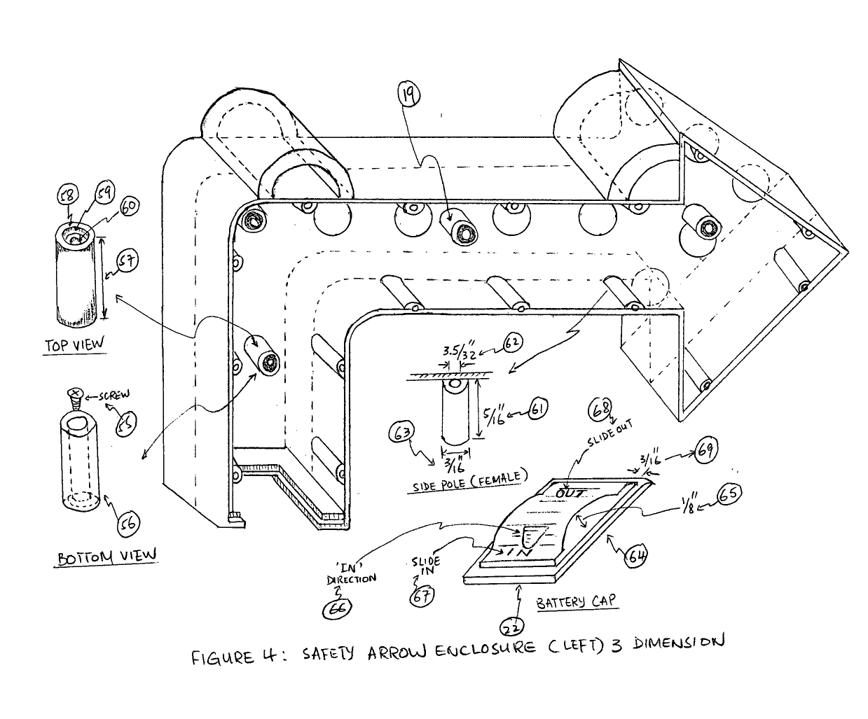

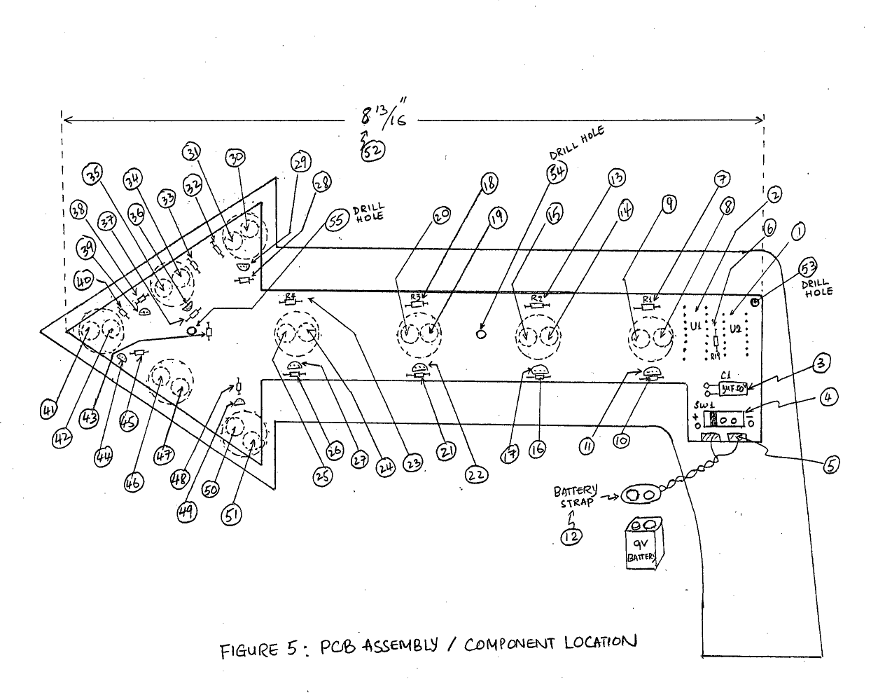

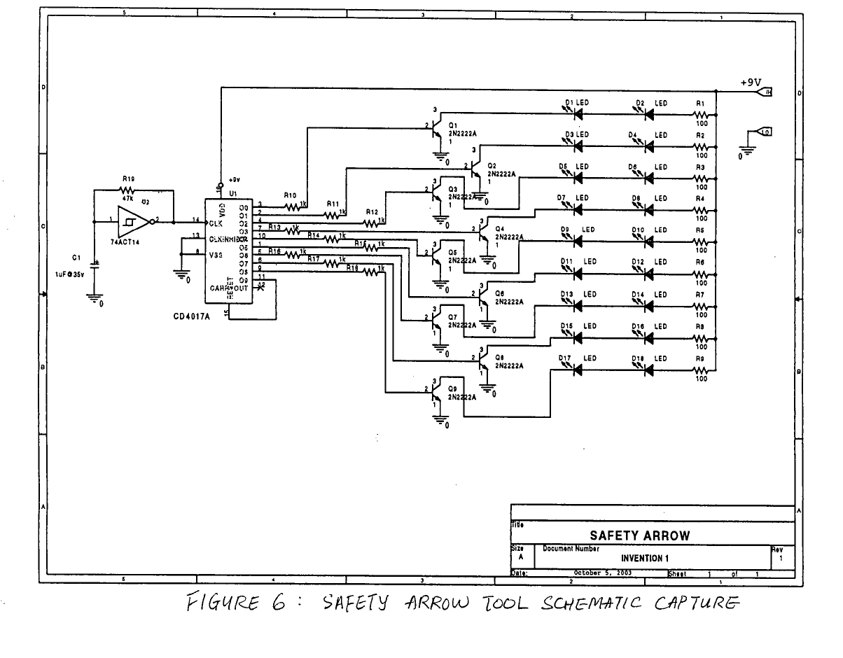

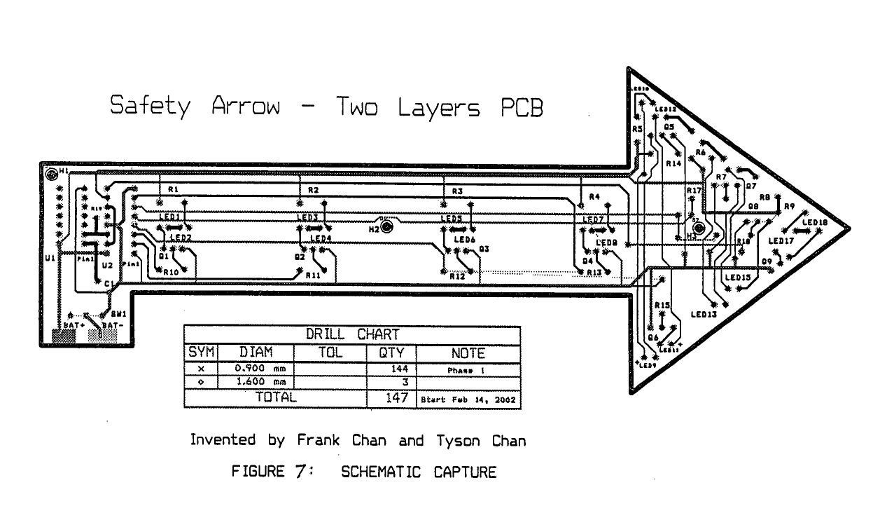

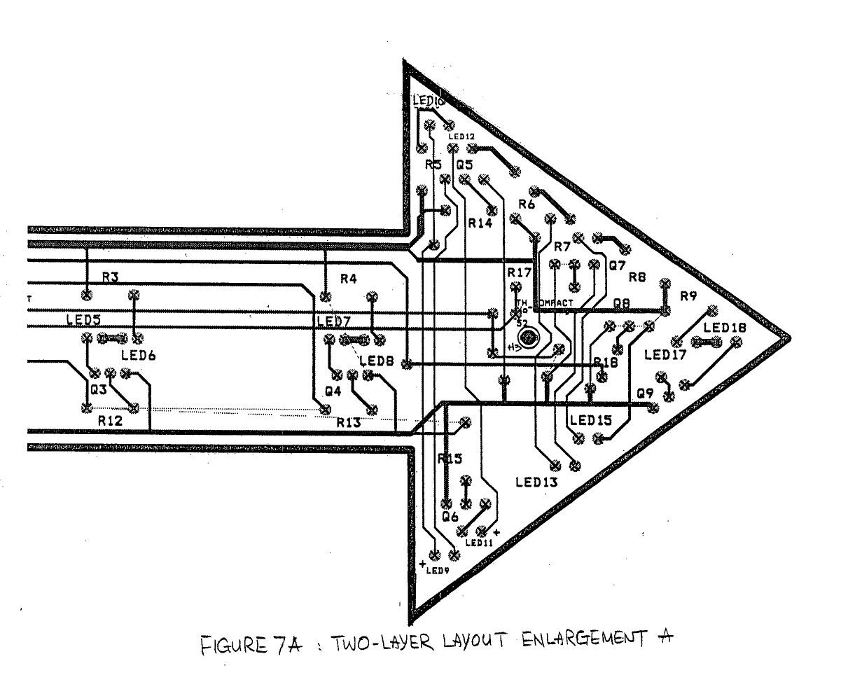

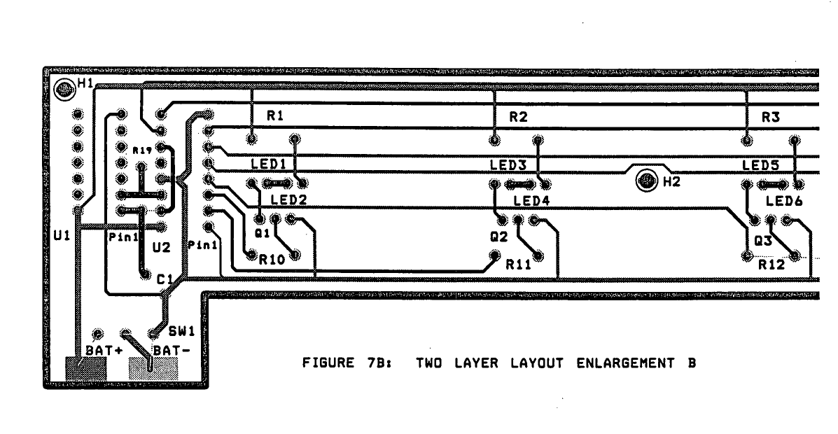

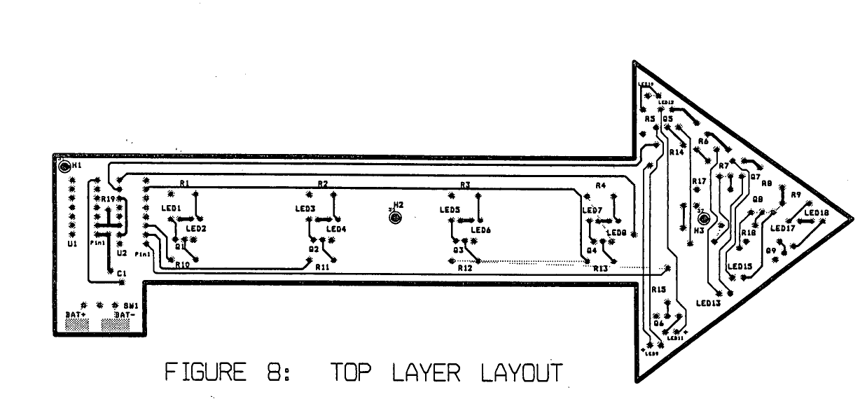

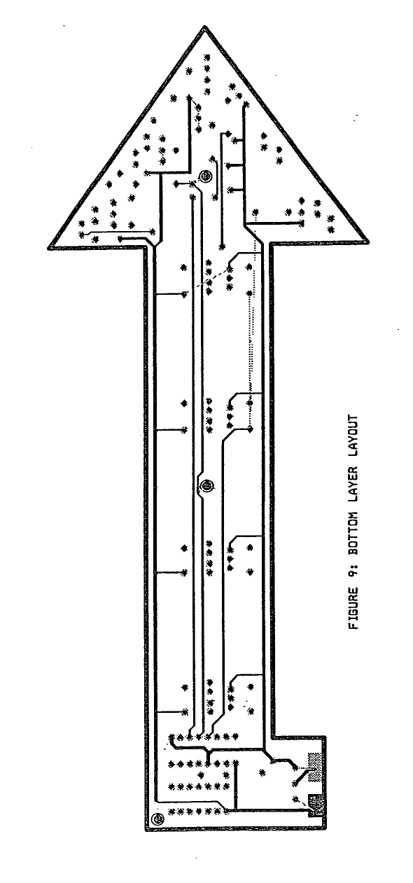

### BACKGROUND OF THE INVENTION

Essentially, the Safety Arrow Tool for Pedestrian of the subject invention comprises:
A. Problem/Solution: Some drivers of the vehicle does not pay attention to the
B. school children across the street to/from school/school zone or going to across the street or when the children did not see the vehicle approaching too close to them or vice versa.
C. There is no indication to help the children to signal to the drivers when they would like to across the street to/from the school/school zone even though they have been waiting a long period of time.
D. Elderly/handicap person should also be benefit when using this convenient tool for their street crossing.

The Safety Arrow for Pedestrian tool can raise the children awareness when they across the street because the children need to switch on the LED/Lamp and lift up the tool and wait till the street is clear as for safety set up by the law in the school zone. This additional tool will help the children pay even more attention when they are crossing the street to/from the school for their safety and cut down the incident with the carelessness of some drivers driving in the school zone.

At night, the Safety Arrow for Pedestrian tool will provide the convenience and benefit to the children and their parents to cross the street eg. to attend the school meeting, symphony, and other activities and this will also help the drivers in awareness that they are approaching to the school zone/area that there is no operation of the school zone flashing light.

### SUMMARY OF THE INVENTION

The intention of the Safety Arrow tool is to provide an additional safety sign of tool to the children and their parents when they cross the street to/from school or in the school zone.

The Safety Arrow for Pedestrian tool also helps out handicap person to across the street and they hardly to be seen when they are sitting on the handicap chair or standing and waiting at the crowded car parking areas in the traffic intersection with/without the traffic light.

The Safety Arrow tool for Pedestrian also provides additional helps to the elderly person to across the street.

For Parent training to the children for safety when they learn how to cross the street.

1. The children may carry the Safety Arrow for Pedestrian Tool to school for their convenience when they across the street in the school zone before and after school.

2. The children's parents may also carry the Safety Arrow for Pedestrian Tool for their convenience when they across the street to pick up their children in the school zone. (eg. In the school zone, Some Mothers carry two or three children to pick up school children and require the extra attention to the drivers slow down carefully for them and the Safety Arrow for Pedestrian Tool will provide the convenience to the Mother and their children when they across the street)

3. Handicap and elderly person require this tool when they across the street without the traffic light at the intersection.

4. A good tool to the safety guard to help out the school children crossing the street.

5. A good tool to help out the school for the drop-off zone as a guiding tool to the vehicles/drivers where they suppose to drop off their children.

6. The safety arrow tool for pedestrian is made by plastic with the electronics circuit that sequentially flashing from one end of the handle toward to the other end of the front pointed arrow.

7. The flashing LED light is passing through the 18-lenses on both sides of the tool as a good indication when a vehicle, bicycle, motorcycle and people approaching to this object.

8. The Safety Arrow enclosure comprising:
A plastic arrow shape enclosure with 18 lenses small circle windows for the flashing LEDs transmit the light through.
A Printed Circuit Board dimension and material list: made of glass epoxy, 1-ounce copper, two-layer layout, 8 13/16″ (Length)×3 5/16″ (Width)×0.62″ (Thickness).
The HEF/CD4017 is a decade counter with ten spike-free decoded active HIGH outputs as indicated from the schematic capture, rev 1
9 axial resistors with 1K ohm, ⅛ watt, carbon film resistor.
9 axial resistors with 100 ohm, ⅛ watt, carbon film resistor.
9 radial Transistor 2N3904, TO-92 package, NPN general purpose amplifier.
18 clear LEDs with 5 mm 2800MCD, super red.
1 axial resistor with 47 k ohm, ⅛ watt, carbon film resistor.
1 capacitor with 1 uF@35 vdc/53 vdc with polarity.
1 hex schmitt trigger inverter.
A 9v battery strap for attaching to the positive (+) and negative (−) terminals on the Printed circuit board.
A standard long lasting 9v power battery is the main source to support the function of the electronic circuit.
A toggle switch with ON/OFF position.

9. A 9V battery is the main power source to support the function of the electronic circuit with a long lasting power.
